(19) United States
(12) Patent Application Publication
(10) Pub. No.: US 2021/0039362 A1
(43) Pub. Date: Feb. 11, 2021

(54) Plastic Film Having High Friction Angle, Rollers, Method of Producing and Uses Thereof

(71) Applicant: SOLMAX INTERNATIONAL INC., Varennes (CA)

(72) Inventors: Simon Gilbert St-Pierre, Boucherville (CA); Guy Elie, Varennes (CA)

(21) Appl. No.: 16/627,508

(22) PCT Filed: Jun. 29, 2018
(86) PCT No.: PCT/CA2018/050808

§ 371 Date: Dec. 30, 2019

Related U.S. Application Data
(60) Provisional application No. 62/526,796, filed on Jun. 29, 2017.

(51) Int. Cl. B32B 27/08; B32B 27/20; B32B 27/32; B29C 48/00; B32B 15/20; B32B 15/085; B32B 15/04; B32B 5/20; B32B 5/32; B32B 7/02

(52) U.S. Cl. CPC B32B 27/08; B32B 2250/03; B32B 27/32; B29C 48/0021; B32B 15/20; B32B 15/085; B32B 15/046; B32B 5/20; B32B 5/32; B32B 7/02; B32B 2323/046; B32B 2264/108; B32B 2264/1022; B32B 2307/202; B32B 2307/402; B32B 2439/70; B32B 2419/00; B32B 27/20

(57) ABSTRACT

A plastic film formed of a layer and at least one skin layer, with the formulation: (i) about 10% to about 70% of a polyethylene resin (e.g. LLDPE, MDPE, HDPE, PERT) of fractional melt index (<0.6 gr/10 min, 190° C., 2.16 kg/min) and a density ranging from 0.910 to 0.960 5 g/cm3; (ii) about 30% to 90% of a LDPE resin of fractional melt index (<1 gr/10 min, 190° C., 2.16 kg/min) and a density from 0.910 to 0.960 g/cm³; (iii) about 0.05 to 0.5 wt % of at least one processing stabilizer; (iv) about 1% to 5 wt % of a UV absorber. The plastic film having asperities, Mohr-Coulomb peak friction angle of >30° and peak adhesion value of >15 kPa for a normal pressure of >100 kPa as per ASTM D-5321. A roll made of the plastic film and a 0 method of producing the plastic film.

### CROSS-REFERENCE TO RELATED APPLICATIONS

The present patent application claims the benefits of priority of commonly assigned U.S. Patent Application No. 62/526,796, entitled “Plastic Film Having High Friction Angle, Rollers, Method of Producing and Uses Thereof” and filed at the United States and Patent Trademark Office USPTO on Jun. 29, 2017.

### FIELD OF THE INVENTION

The present invention generally relates to geomembrane liners, and more particularly to multilayer polyethylene geomembrane liners with textured surfaces showing high friction angles that enables them to be used at critical designs.

### BACKGROUND OF THE INVENTION

Polyethylene geomembranes are used extensively as a part of liquid containment systems in different applications such as in modern landfills or heap leach in mining industry. In all those applications the geomembrane is part of a system including geotextile and/or geosynthetic clay liner (GCL) as well as geomembranes. The integrity of this lining system is dependent on the cohesion between the different layers. Since the regular gluing mechanism cannot be used for this application with all the chemicals used and the big scale of the work, that integrity depends on the friction between the layers. The surface of the geomembranes can be texturized to increase friction via different methods such as described in U.S. Pat. Nos. 4,885,201, 5,403,126 and 5,258,217.

There are different methods for producing polymeric films namely “cast film process” and “blown film process”. In the latter process, the molten polymer is pushed into a die with annular die-exit where it forms a tube being pulled upward by the winders. The die exit is equipped with high efficiency high pressure air cooling system which blows cool air on the surface of the film from both sides to cool down the polymer and freeze the molecular structure as early as possible. The efficiency of the cooling system will determine the final properties of the film. The tube diameter and film thickness are controlled by blow-up and take-up ratios.

Today most of the Polyethylene geomembranes are made in three layers by co-extrusion, similar to the trend in food packaging film industry. Multilayer structure provides the possibility to customise the product for different applications. One of the advantages of a multilayer structure is using different materials in the core and skin layers to get the benefits of both materials such as HD/LL/HD combination (Chapter 3, HDPE Geomembranes; in A Guide to Polymeric Geomembranes, John Schiers, 2009, John Wiley & Sons). Another very important benefit of multilayer structure is the possibility of texturizing the skin layers without affecting the physical-mechanical properties of the thick core layer. JD Green (U.S. Pat. No. 5,763,047) introduces a method of texturizing the surface layer of the geomembranes with nitrogen or any other blowing agent. This dissolved blowing agent bursts into projections on the surface of the film at the die exit due to the sudden pressure drop. This phenomenon results in randomly textured surface. There are some other methods of texturizing the surface of films in general and geomembranes specifically. Among them is embossing method that is used in cast film processes where a desired pattern can be embossed on the film (U.S. Pat. No. 4,290,248). Another method is called spray-on method (U.S. Pat. No. 5,728,424) where a compatible resin is sprayed on the film right out of the die at high enough temperature to create a molecular level interaction with the surface molecules (welding).

Many of these methods are created for the cast film process technic. The only industrial method now for the blown film process is via foaming skin layer as described above. Since the texturizing technic is almost the same, the final frictional properties of the films are more dependant on the initial formulation of the skin layer rather than on the technic itself. This difference is very obviously observed in the industry between a conductive geomembrane (e.g. Solmax Conductive PE geomembrane) and a regular PE geomembrane. The former shows a special structure at the surface which results in increased friction angles way higher than the regular materials.

But there is a very important technical problem with that type of material and that is welding over the edges between the adjacent liners. Due to the special skin formulations of conductive products, there is a high content of carbon black in the skin layer. This un-melt-able ingredient interferes with the welding process on the site in a way that the speed of welding reduces dramatically and the installers need to get special training on that. In some other conditions, the installers even need to get a specially designed welding machine for that specific type of geomembrane (U.S. Pat. No. 9,033,620B2).

On the other hand, designers are increasing the safety factors every day and this translates to designing higher friction factor geomembranes. This is easier to reach for the cast film process, but a great portion of the geomembrane industry is using the blown film process.

Hence, the suppliers of geomembranes using the blown film process are in certain need for a new material and/or method to develop high friction factor geomembranes without the troubles indicated above.

### SUMMARY OF THE INVENTION

The invention is directed to multilayer polyethylene films having N layers where N>2; where each layer can be made of different kind of polyethylene such as, but not limited to: High density Polyethylene (HDPE), Medium Density Polyethylene (MDPE), linear low density Polyethylene (LLDPE), Low density polyethylene (LDPE) and Polyethylene for Raised Temperature (PERT) as well as thermoplastic elastomers (TPEs) or thermoplastic olefins (TPOs), as long as every two adjacent layers are compatible.

It is disclosed a new formulation to be used in the skin layers, 2, of the multilayer PE film of textured plastic films to improve frictional properties.

In an embodiment of this invention, the skin layer is formulated in a way that it resists cell coalescence in cell growth step of foaming. This ability avoids coalescence and therefore very small cells are created and maintained until reaching the surface and rupture.

Additionally, the solubility of the gas, injected directly to the melt or created during processing, and dispersion of the gas within the molten polymer is considerably improved. This results in more homogeneous cell dispersion over the surface and better friction factors.

In another embodiment of this invention, the final formulation of the skin layer is expressed as:
About 10% to about 70% of a polyethylene type resin;
About 30% to about 90% of LDPE,
About 1% to about 2% of processing stabilizer and antioxidants, and
About 1% to about 5% of a UV absorber

In another embodiment of this invention, the final formulation of the skin layer is expressed as:
About 10% to about 70% of LLDPE or HDPE
About 30% to about 90% of LDPE,
Optionally about 20% to about 50% of PP,
Optionally about 5% to 20% of an Ethylene-Propylene copolymer,
About 1% to about 2% of processing stabilizer and antioxidants,
About 1% to about 5% Carbon black of any type (A summary of the main aspects of the invention).

In accordance with a preferred embodiment, the composition of the skin layer as disclosed herein, the said Carbon black is replaced by about the same amount of Titanium dioxide (TiO₂) additive.

In accordance with a preferred embodiment, one of the layers of the multilayer PE liners disclosed herein may be free of carbon black.

In accordance with a preferred embodiment, one of the layers of the multilayer PE liners disclosed herein is free of carbon black and comprises Titanium oxide (TiO₂).

In accordance with a preferred embodiment, the other layers of the multilayer plastic film can be of any composition of polymers and/or additives and/or fillers.

In another embodiment of the invention the textured layer, is a part of a composite multilayer structure of polymeric and metallic layers in a form of sandwich panel that is laminated on each other.

In accordance with a preferred embodiment, the adaptable structure of the multilayer liner disclosed herein will allow the manufacturer to design targeted formulations at each layer. For instance, in a 3-layer structure, FIG. 1, where the outer layers counts for 5% of the thickness, the layer which is not in contact with heat source does not necessarily need to be boosted by high performance additives and regular additives will fulfill the requirements. Also, as an example, the same structure will allow incorporation of reflective pigments on the layer which fronts onto sunlight and still keep the cost reasonable enough. Other configurations can be provided without departing from the invention as disclosed herein.

Other and further aspects and advantages of the present invention will be obvious upon an understanding of the illustrative embodiments about to be described or will be indicated in the appended claims, and various advantages not referred to herein will occur to one skilled in the art upon employment of the invention in practice

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an illustration of a multilayer plastic film structure.

FIG. 2, is an illustrative demonstration of the two types of textured surface.

FIG. 3 is real optical microscope photos of the two different types of textured surface.

### DETAILED DESCRIPTION OF THE PREFERRED EMBODIMENT

A novel textured geomembrane will be described hereinafter. Although the invention is described in terms of specific illustrative embodiments, it is to be understood that the embodiments described herein are by way of example only and that the scope of the invention is not intended to be limited thereby.

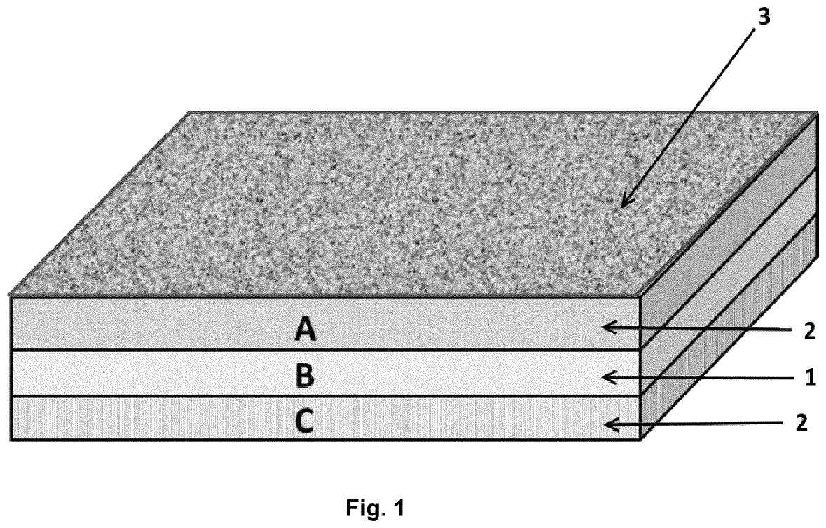

FIG. 1 illustrates a multilayer plastic film structure in accordance with preferred embodiment of the invention, in which the scales of the layers are merely for illustrative purposes and may not be in the desired thickness ratio, where it comprises of one core layer, 1, and two skin layers, 2, with a textured surface 3.

The films produced with this method may have an average thickness of preferably about 20 mils to about 120 mils. These films will be generally used in applications related to, but not limited to, the geomembranes such as in primary and secondary containments of different liquids like water, leachate, slurry, sludge, tailings, pregnant solution, brine and similar or any other applications of geomembranes in the art.

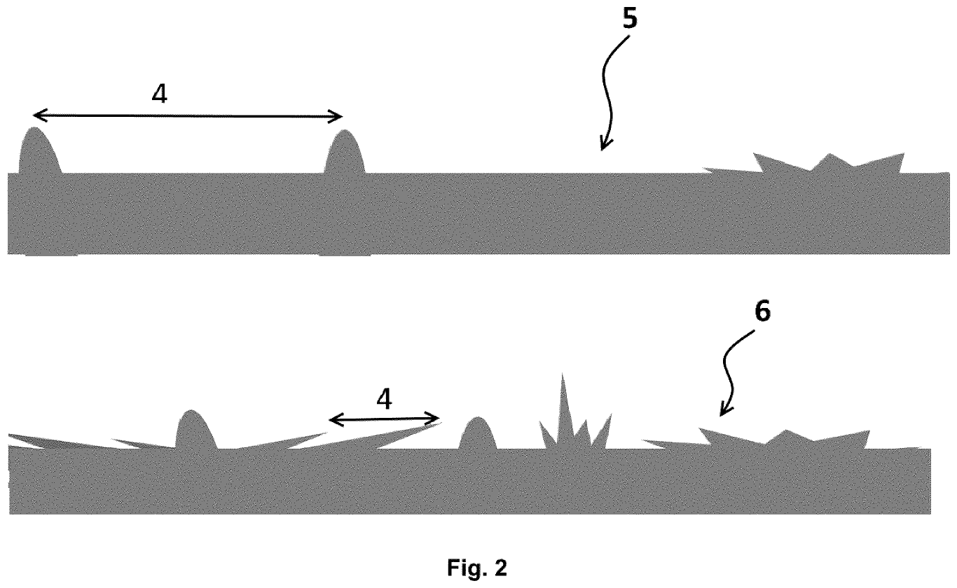

FIG. 2, is an illustrative demonstration of the two types of textured surface, 5, the regular textured, 6, the new textured with novel formulation. The points used to measure the distance between peaks, 4, are shown on this figure.

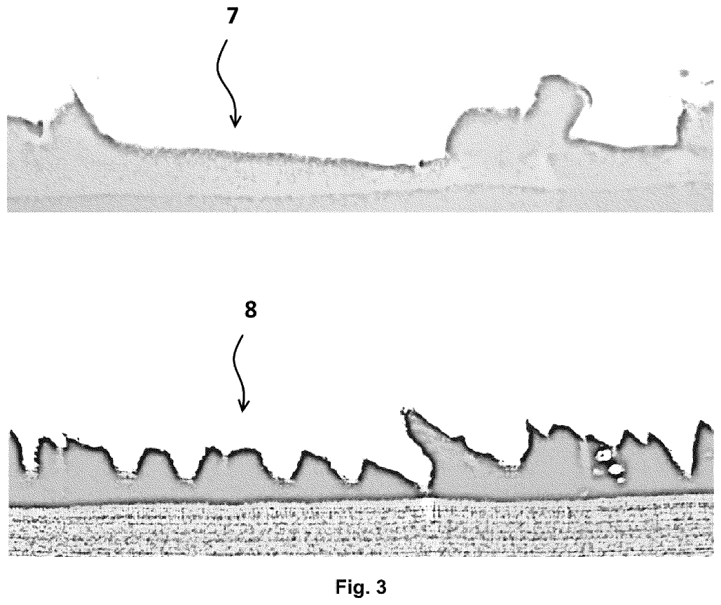

FIG. 3 is real optical microscope photos of the two different types of textured surface, 7, regular formulation textured surface, 8, invented new formulation textured surface.

As used herein % or wt. % means weight % unless otherwise indicated. When used herein % refers to weight % as compared to the total weight percent of the phase or composition that is being discussed.

By “about”, it is meant that the value of weight %, time, pH or temperature can vary within a certain range depending on the margin of error of the method or device used to evaluate such weight %, time, pH or temperature. A margin of error of 10% is generally accepted.

The surface texture of the films can be totally or partially textured. The film can be a monolayer or multilayer structure and each layer may or may not have the structure of the skin layer. In some cases, some of the layers are non-polymeric and/or a mix of polymeric and/or non-polymeric materials.

A novel product with improved Mohr-Coulomb peak friction angle of >30° and peak adhesion value of >15 kPa for a normal pressure of >100 kPa at stress curve undergone according to ASTM D-5321 against needle punched geotextile, and regular weldability properties is described hereinafter. Although the invention is described in terms of specific illustrative embodiments, it is to be understood that the embodiments described herein are by way of example only and that the scope of the invention is not intended to be limited thereby.

The average horizontal distance of the asperities' peaks from one peak to the nearest peak, 4 (FIG. 2), is preferably less than 250 μm;

In accordance with a preferred embodiment, either or both skin layers, may have any combination of the followings:
1) LLDPE and/or MDPE resin of fractional melt index (<0.5 gr/10 min, 190° C., 2.16 kg/min) (e.g. Marlex K306 or Marlex 7104, Chevron Phillips);
2) LDPE resin of fractional melt index (<1 gr/10 min, 190° C., 2.16 kg/min) (e.g. Dow LDPE 132i);
3) optionally, Polypropylene resin of long chain branched type of any melt index (e.g. Daploy WB140HMS, Borealis AG);
4) optionally, Ethylene-Propylene copolymer of any type (e.g. fPP Hifax CA10A, LyondellBasell);
5) optionally UV stabilizers functioning as free radical scavengers in Hindered Amine Light Stabilizer (“HALS”) family (e.g., Chimmasorb 2020™ (BASF, Germany));
6) optionally, antioxidants functioning as inhibitors of thermo-oxidative degradation at a broad temperature range for long-term thermal stabilizers in hindered phenolic family (e.g., Irganox 1010™ (BASF, Germany), which is a sterically hindered phenolic antioxidant);
7) process or thermal stabilizers functioning as inhibitors of thermo-oxidative degradation during extrusion process in comprising a phosphite processing stabiliser (e.g., Irgafos 168™ (BASF, Germany)); and/or
8) optionally, a UV absorber such as carbon black, preferably a furnace carbon black with particle size equal or below N660, or TiO₂, preferably with particle size of 100 nm and/or any other colorant and more.

The use of carbon black in exposed conditions will cause increasing the temperature of the liner under sun. The use of TiO₂ in the outer layer will help the liner retain its Physical-thermal-mechanical properties for longer times due to its light reflection properties.

In accordance with a preferred embodiment, either or both skin layers, 2, may have any combination of the followings:
1) about 10 to about 70% of a polyethylene resin (LLDPE, MDPE, HDPE, PERT) of fractional melt index (<0.5 gr/10 min, 190° C., 2.16 kg/min) and density of 0.910 to 0.960 g/cm³ (e.g. Marlex K306 or Marlex 7104, Chevron Phillips);
2) about 30 to about 90% of a LDPE resin of fractional melt index (<1 gr/10 min, 190° C., 2.16 kg/min) and density of 0.910 to 0.960 g/cm³ (e.g. Dow LDPE 132i);
3) optionally, about 20 to about 50% of a Polypropylene resin of long chain branched type of any melt index (e.g. Daploy WB140HMS, Borealis AG);
4) optionally, about 5 to about 20% of a Ethylene-Propylene copolymer of any type (e.g. fPP Hifax CA10A, LyondellBasell);
5) optionally, about 0.1 to about 0.5 wt % of a phenolic antioxidants, wherein said antioxidant may include pentaerythritol tetrakis (3-(3,5-di-tert-butyl-4-hydroxyphenyl)propionate);
6) about 0.05 to about 0.5 wt % of a secondary phosphite antioxidant such as Tris (2,4-ditert-butylphenyl) phosphite;
7) optionally, about 0.05 to about 0.5 wt % of a UV stabilizer of high molecular weight hindered amines (HALS) family such as 1,6-Hexanediamine, N,N′-bis (2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine;
8) about 1% to about 5 wt % of a UV absorber such as carbon black or TiO₂, wherein the said UV absorber is preferably a furnace carbon black;
   wherein the percentages by weight add up to 100% and are based on the total weight of the master batch composition.

### Example

In a three-layer plastic film of 1.5 mm thick, with skin layers of 0.12 mm each, the following formulation has been used:

| Layer | Layer A | Layer B | Layer C |
|---|---|---|---|
| ingredients | wt % | wt % | wt % |
| LDPE | 50 | 0 | 0 |
| 132i, Dow | | | |
| MDPE | 42.28 | 92.28 | 8828 |
| K306, Chevron | | | |
| Carbon Black | 2.5 | 2.5 | 0 |
| N 550 | | | |
| TiO₂ | 0 | | 4.5 |
| (Ti-pure © by Dupont) | | | |
| Irganox ™ 1010 | 0.12 | 0.12 | 0.12 |
| Irgafos 168 | 0.1 | 0.1 | 0.1 |
| Masterbatch resin | 5 | 5 | 7 |
| LLDPE | | | |
| Thickness (%) | 1-10 | 80-98 | 1-10 |

Blending the ingredients of each layer before feeding to the extrusion line, and processing, and injecting gas in the beginning of the metering zone of extruder of layer A to the molten plastic, will result in a structure shown in FIG. 3 (8) and peak friction angle of 32° at the pressure of 200 kPa when in contact with a needle punched geotextile.

In reference to the figures, it is also disclosed a plastic film comprising:
a. a main part, “core layer”, 1, formed of a layer having an average thickness preferably of at least 0.254 mm thick across the width; and
b. at least one skin layer, 2, covering minimum 70% of the surface of plastic film, having a thickness that is preferably less than about 25% of the average thickness of core layer, with the following formulation:
   i. about 10% to about 70% of a resin of polyethylene type (e.g. LLDPE, MDPE, HDPE, PERT) of fractional melt index (<0.6 gr/10 min, 190° C., 2.16 kg/min) and of a density ranging from 0.910 to 0.960 g/cm³ (e.g. Marlex K306 or Marlex 7104, Chevron Phillips);
   ii. about 30% to about 90% of a LDPE resin of fractional melt index (<1 gr/10 min, 190° C., 2.16 kg/min) and of a density ranging from 0.910 to 0.960 g/cm³ (e.g. Dow LDPE 132i);
   iii. optionally, about 20% to about 50% of a Polypropylene resin of long chain branched type of any melt index (e.g. Daploy WB140HMS, Borealis AG);
   iv. optionally, about 5% to about 20% of a Ethylene-Propylene copolymer of any type (e.g. fPP Hifax CA10A, LyondellBasell);
   v. optionally, about 0.1% to about 0.5 wt % of a phenolic antioxidants, wherein said antioxidant may include pentaerythritoltetrakis (3-(3,5-di-tert-butyl-4-hydroxyphenyl) propionate);
   vi. about 0.05 to about 0.5 wt % of a at least one processing stabilizer preferably of secondary phosphite antioxidant type such as Tris (2,4-ditert-butylphenyl) phosphite;
   vii. optionally about 0.05 to about 0.5 wt % of a UV stabilizer of high molecular weight hindered amines (HALS) family such as 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine; and
   viii. about 1% to about 5 wt % of a UV absorber such as carbon black or TiO₂, wherein the said UV absorber is preferably a furnace carbon black,
      wherein preferably:
the percentages by weight add up to 100% and are based on the total weight of the skin composition;
the said skin layer(s) have asperities, 3, being made of the same material of the skin layer(s), causing Mohr-Coulomb peak friction angle of >30° and causing peak adhesion value of >15 kPa for a normal pressure of >100 kPa at stress curve undergone according to ASTM D-5321 when in contact with non-woven needle punched geotextile, and said skin layers having preferably regular weldability properties as per industry standard of GRI GM 19;
optionally, the shape of asperities are mostly conical with sharp or semi-sharp peaks, the other asperities having mainly random shapes;
optionally, the orientation of the asperities' edges are quite random and pointing out of the skin;
the average horizontal distance of the asperities' peaks from one peak to the nearest peak, 4, is preferably less than 250 μm;
optionally, the said asperities cover more than 90% of the surface of the skin layer; and
the asperities can be individual or interconnected, 6.

Preferably, the carbon black content of the skin layer is below 3%.

Preferably, at least one longitudinal strip of smooth surface is located at a peripheral edge of the plastic film.

Preferably, the plastic film is made of a natural or synthetic polymer, and is more preferably made of at least one of the followings: High density Polyethylene (HDPE), Medium Density Polyethylene (MDPE), linear low density Polyethylene (LLDPE), Low density polyethylene (LDPE) and Polyethylene for Raised Temperature (PERT) as well as thermoplastic elastomers (TPEs) or thermoplastic olefins (TPOs), or any combination thereof.

Preferably, the plastic film is filled with any kind of fillers, micro-fillers or nano-fillers such as, but not limited to, short or long glass fibers, talk, fire retardants, carbon black or conductive additives.

Preferably, the plastic film is smooth at either sides of the film.

Preferably, the plastic film is textured on one side or both sides of the film.

Preferably, the plastic film is at least partially colored on at least one side of the film.

Preferably, the plastic film is at least partially conductive on at least one side.

Preferably, the plastic film is a geomembrane liner, wherein the liner is used for waste containment, contaminated soil containment, fluid containment, mining containment, capping, secondary containment, dam, canal, fluid control.

Preferably, the plastic film is composed of N layers, N being an integer, and N being superior or equal to 2.

Preferably, in the plastic film, at least one layer is not conductive, or only partially conductive.

Preferably, the plastic film has been obtained by coextrusion.

Preferably, the plastic film has been obtained partially or completely by lamination technique.

Preferably, the plastic film has been obtained by any combination of coextrusion and lamination techniques.

Preferably, in the plastic film, at least one layer is of a different thickness profile than the other layer(s).

Preferably, in the plastic film, at least one layer is made of a synthetic and/or of a natural polymer.

Preferably, in the plastic film, at least one layer is made of non-polymeric material such as metals, e.g. aluminum or copper.

Preferably, the plastic film is a multilayer sandwich panel of one or more plastic layers and of one or more metal layers, like aluminum, to be used in construction applications, or laminated packaging film of similar structure in food packaging applications.

It is also disclosed roller made of a plastic film as defined herein rolled on a spool.

It is also disclosed a method of producing a plastic film, comprising the steps of:
a. mixing the LDPE and/or the PP is(are) mixed with at least the LLDPE,

MDPE, HDPE and PERT resin of choice, preferably before extrusion feeding, more preferably before a hopper or in a hopper; and
b. mixing at least one blowing agent (foaming agent), of the physical and/or of the chemical type, with the mixture resulting of the step (a), wherein the mixing takes place:
   in the hopper or before feeding into the hopper; and/or
   in the initial zones of the extruder, before or during processing; and/or
   through injection into molten polymer in a extruder during the extrusion of the skin layer(s),
in a way that when the molten mixture of step (b) exits the die of the extruder, pressure drops to atmospheric pressure and cells grow and burst out to create textured surface (appearance of asperities).

Preferably, in the method, the die of the extruder is of the blown film die type.

Preferably, in the method, the die of the extruder is of the cast film die type.

Preferably, in the method, the blowing agent is N₂ or CO₂ or any mixture thereof and the blowing agent is injected into the molten polymer in metering zone of extruder screw.

Preferably, in the method, the blowing agent is a physical or chemical blowing agent premixed with the resin in the hopper or added separately in the initial zones of the extruder.

Preferably, in the method, the film is made from a natural or synthetic polymer, and is preferably made of at least one of the followings: High density Polyethylene (HDPE), Medium Density Polyethylene (MDPE), linear low density Polyethylene (LLDPE), Low density polyethylene (LDPE) and Polyethylene for Raised Temperature (PERT) as well as thermoplastic elastomers (TPEs) or thermoplastic olefins (TPOs), or any combination thereof.

Preferably, in the method, the plastic film is smooth on either sides.

Preferably, in the method, the plastic film is textured on one side or both sides by using complementary extrusion equipment.

Preferably, in the method, the film is colored on one or both sides by adding a color masterbatch before extrusion takes place.

Preferably, in the method, the liner is conductive on one side or both sides including or excluding the peripheral edges.

It is also disclosed the use of the plastic film as defined herein or of a plastic film obtained by using the method defined herein, in applications such as geomembrane liners, capping and covers, packaging films, shopping bags, shrink films, silage films and similar.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A plastic film having:
a) a main part, “core layer”, 1, wherein said core layer is made from a natural or synthetic polymer; and
b) at least one skin layer, 2, covering a minimum of 70% of the surface of the plastic film, having a thickness that is less than about 25% of the average thickness of the core layer, wherein said skin layer has the following formulation:
10% to 70% of a resin of polyethylene type of fractional melt index (<0.6 gr/10 min, 190° C., 2.16 kg/min) and of a density ranging from 0.910 to 0.960 g/cm³; and
30% to 90% of a LDPE resin of fractional melt index (<1 gr/10 min, 190° C., 2.16 kg/min) and of a density ranging from 0.910 to 0.960 g/cm³,
wherein the percentages are by weight and are based on the total weight of the master batch composition.

2. (canceled)

3. The plastic film according to claim 1, wherein said skin layer further comprising: 20% to 50% of a Polypropylene resin of long chain branched type of any melt index.

4. The plastic film according to any one of claim 1, wherein said skin layer further comprising 5% to 20% of an Ethylene-Propylene copolymer of any type.

5. The plastic film according to any one of claim 1, wherein said skin layer further comprising 0.1% to 0.5 wt % of a phenolic antioxidant.

6. The plastic film according to claim 5, wherein said antioxidant includes pentaerythritoltetrakis(3-(3,5-di-tert-butyl-4-hydroxyphenyl)propionate).

7. The plastic film according to claim 1, wherein said skin layer further comprises 0.05 to 0.5 wt. % of a at least one processing stabilizer.

8. The plastic film according to claim 1, wherein said skin layer further comprises 0.05 to 0.5 wt % of a UV stabilizer of high molecular weight hindered amines (HALS) family.

9. The plastic film according to, claim 1 wherein said skin layer further comprises 1% to 5 wt % of a UV absorber.

10. The plastic film according to claim 9, wherein said UV absorber is carbon black, furnace carbon black or TiO₂.

11. The plastic film according to claim 1, wherein the said skin layer has asperities, 3, being made of the same material of the skin layer, causing Mohr-Coulomb peak friction angle of >30° and causing peak adhesion value of >15 kPa for a normal pressure of >100 kPa at stress curve undergone according to ASTM D-5321 when in contact with non-woven needle punched geotextile.

12. The plastic film according to claim 11, wherein said skin layer has regular weldability properties as per industry standard of GRI GM 19.

13. The plastic film according to claim 11, wherein the shape of the asperities are conical.

14. The plastic film according to claim 11, wherein the asperities have sharp or semi-sharp peaks.

15. The plastic film according to claim 11, wherein the orientation of the asperities' peaks is random and pointing out of the skin.

16. The plastic film according to claim 1, wherein the average horizontal distance of the asperities' peaks from one peak to the nearest peak, 4, is less than 250 μm.

17. The plastic film according to claim 1, wherein the said asperities cover more than 90% of the surface of the skin layer.

18. The plastic film according to claim 1, wherein the asperities can be individual or interconnected, 6.

19. The plastic film according to claim 1, wherein the skin layers has a carbon black content below 3%.

20. The plastic film according to claim 1, wherein at least one longitudinal strip of smooth surface is located at a peripheral edge of the plastic film.

21. The plastic film according to claim 1, wherein said plastic film is made of a natural or synthetic polymer.

22. The plastic film according to any one of claims 1 to 21, wherein said plastic film is made of at least one of the following: High density Polyethylene (HDPE), Medium Density Polyethylene (MDPE), linear low density Polyethylene (LLDPE), Low density polyethylene (LDPE) and Polyethylene for Raised Temperature (PERT) as well as thermoplastic elastomers (TPEs) or thermoplastic olefins (TPOs), or any combination thereof.

23. (canceled)

24. (canceled)

25. The plastic film, according to claim 1, said plastic film being smooth on either side of the film.

26. The plastic film according to claim 1, said plastic film being textured on one side or both sides of the film.

27. The plastic film according to claim 1, said plastic film being at least partially colored on at least one side of the film.

28. The plastic film according to claim 1, said plastic film being at least partially conductive on at least one side.

29. The plastic film according to claim 1, wherein at least one layer is not conductive, or only partially conductive.

30. The plastic film according to claim 1, wherein said plastic film is a geomembrane liner.

31. The plastic film according to claim 30, said plastic film being composed of N layers, N being an integer, and N being superior or equal to 2.

32. (canceled)

33. The plastic film according to claim 1, wherein the plastic film is obtained partially or completely by lamination technique.

34. The plastic film according to claim 1, wherein the plastic film is obtained by any combination of coextrusion and lamination techniques.

35. (canceled)

36. (canceled)

37. The plastic film according to claim 1, wherein at least one layer is made of non-polymeric material.

38. The plastic film according to claim 1, wherein the plastic film is a multilayer sandwich panel of one or more plastic layers and of one or more metal layers.

39. (canceled)

40. (canceled)

41. A method of producing a plastic film according to claim 1, said method being an extrusion process comprising the following steps:
a. in a first mixing step, the LDPE and/or the PP is(are) mixed with at least the LLDPE, MDPE, HDPE and PERT resin of choice; and
b. in a second mixing step, at least one blowing agent (foaming agent), of the physical and/or of the chemical type, is mixed with the mixture resulting of the step (a), wherein the pressure drops to atmospheric pressure and cells grow and burst out to create textured surface by appearance of asperities when the mixture of step (b) exits the die of the extruder.

42. (canceled)

43. (canceled)

44. (canceled)

45. (canceled)

46. (canceled)

47. (canceled)

48. (canceled)

49. (canceled)

50. (canceled)

51. The method of claim 41, wherein the plastic film is smooth on either side.

52. The method of claim 41, wherein the plastic film is textured on one side or both sides by using complementary extrusion equipment.

53. The method of claim 41, wherein the film is colored on one or both sides by adding a color masterbatch before extrusion takes place.

54. The method of claim 41, wherein the liner is conductive on one side or both sides including or excluding the peripheral edges.

55. (canceled)

56. (canceled)

57. (canceled)

58. (canceled)

59. The plastic film according to claim 7, wherein said processing stabilizer is Tris(2,4-ditert-butylphenyl)phosphite.

60. A three-layer plastic film having the following formulation:

| Layer | Layer A | Layer B | Layer C |
|---|---|---|---|
| ingredients | wt % | wt % | wt % |
| LDPE | 50 | 0 | 0 |
| 132i, Dow | | | |
| MDPE | 42.28 | 92.28 | 88.28 |
| K306, Chevron | | | |
| Carbon Black | 2.5 | 2.5 | 0 |
| N 550 | | | |
| TiO₂ | 0 | | 4.5 |
| (Ti-pure © by Dupont) | | | |
| Irganox ™ 1010 | 0.12 | 0.12 | 0.12 |
| Irgafos 168 | 0.1 | 0.1 | 0.1 |
| Masterbatch resin | 5 | 5 | 7 |
| LLDPE | | | |
| Thickness (%) | 1-10 | 80-98 | 1-10 |
